(19) United States
(12) Patent Application Publication
(10) Pub. No.: US 2026/0348403 A1
(43) Pub. Date: Nov. 5, 2026

(54) DEVICE FOR CONTROLLING A KAPLAN-TYPE HYDRAULIC MACHINE

(71) Applicant: Voith Patent GmbH, Heidenheim (DE)

(72) Inventors: Thomas Zeller, Aalen (DE); Rouven Hohage, Buxheim (DE)

(73) Assignee: Voith Patent GmbH, Heidenheim (DE)

(21) Appl. No.: 19/705,518

(22) Filed: Jun. 11, 2026

Related U.S. Application Data
(63) Continuation of application No. PCT/EP2024/083267, filed on Nov. 22, 2024.

(30) Foreign Application Priority Data
Dec. 11, 2023 (DE) 10 2023 134 581.8
Nov. 22, 2024 (WO) PCT/EP2024/083267

(51) Int. Cl. F15B 11/17; F15B 1/04; F15B 13/02

(52) U.S. Cl. CPC F15B 11/17; F15B 1/04; F15B 13/027

(57) ABSTRACT

A device for controlling a Kaplan-type hydraulic machine includes an impeller unit, including a first pump assembly with a variable speed drive and an accumulator, a hydraulic cylinder, two pilot-operated check valves and two pilot valves to unlock the check valves, the first pump assembly including a pump with reversible delivery direction connected with the pump drive such that the pumps can be driven by the drive in both delivery directions, the device including a collection and expansion tank, the impeller unit including a second pump assembly with a variable speed pump drive, a hydraulic rotary union, a throttle, two additional pilot-operated check valves and two additional pilot valves to unlock the check valves, the second pump assembly including an additional pump with reversible delivery direction, connected with the associated variable speed pump drive, so that the additional pump can be operated in both delivery direction by the pump drive.

### CROSS REFERENCE TO RELATED APPLICATIONS

This is a continuation of PCT application no. PCT/EP2024/083267, entitled “DEVICE FOR CONTROLLING A KAPLAN-TYPE HYDRAULIC MACHINE”, filed Nov. 22, 2024, which is incorporated herein by reference. PCT application no. PCT/EP2024/083267 claims priority to German patent application no. 10 2023 134 581.8, filed Dec. 11, 2023, which is incorporated herein by reference.

### BACKGROUND OF THE INVENTION

### 1. Field of the Invention

The present invention relates to hydraulic machines.

### 2. Description of the Related Art

Conventionally, the energy required for adjusting the impeller blades is provided in the form of pressure and volume flow by a hydraulic accumulator with a downstream control valve. In this open system, the accumulator pressure is throttled via the opening of the control valve until the necessary volume flow is achieved for the required cylinder movement. With this technology, both differential cylinders and double-rod cylinder cylinders can be controlled without restriction.

Other devices for regulating a hydraulic machine have become known from the state of the art. For example, DE 10 2017 106 693 B3 discloses such a device, which is also suitable in principle for regulating the impeller of a Kaplan machine. The disclosed device uses a variable-speed pump assembly, which is connected to a hydraulic cylinder via pilot-operated check valves. However, this presents various difficulties, which are related to the fact that the hydraulic cylinder used to pivot the impeller blades is part of the rotating system of the hydraulic machine, while the rest of the device is part of the stationary system. To allow the hydraulic fluid (usually oil) used to actuate the hydraulic cylinder to flow from the stationary system to the rotating system and back again, a hydraulic rotary union is typically provided, which in hydropower applications is called an oil head. Hydraulic rotary unions generally exhibit a certain amount of internal oil leakage, which is also required to cool and lubricate the bearings of the hydraulic rotary union. Depending on the type, the pressure applied to the hydraulic rotary union, and the current oil temperature, the internal oil leakage can range from 0.5 to 200 l/min. To keep the impeller in position (the most common operating mode, approximately 90% of operating time), continuous control is necessary to compensate for the drift of the hydraulic cylinder (caused by leakage from the hydraulic rotary union).

If the device disclosed in DE 10 2017 106 693 B3 is to be used for controlling the impeller blade position of a Kaplan machine, various difficulties arise depending on the type of pump used. Using a gear pump is problematic because gear pumps are not approved for continuous operation at the low speeds required to keep the impeller in position. The resulting rapid pump wear excludes this option. Using a piston pump allows for continuous operation at low speeds and high pressure without problems. However, the following aspects lead to significantly increased losses in such a system. For permissible continuous operation, piston pumps must be supplied with flushing oil. In addition to the constant operation of an additional flushing pump, this also results in additional constant losses in the system. In addition, the pilot-operated check valves must also be permanently opened during continuous operation of the pump. As a result, the internal pump leakage of the piston pump would be continuously eliminated from the accumulator as a further loss.

What is needed in the art is to modify the device disclosed in DE 10 2017 106 693 B3 in such a way that it can be used efficiently and reliably over an extended period of time to control the impeller of a Kaplan machine.

### SUMMARY OF THE INVENTION

The present invention relates to a device for controlling a Kaplan-type hydraulic machine, also known as a Kaplan machine. Kaplan machines include an impeller with pivotable impeller blades. The present invention relates to a device by which the pitch angle of the impeller blades can be controlled. A Kaplan machine also includes an adjustable wicket gate assembly. The present invention relates in particular to the combined control of the impeller and wicket gate assembly of the hydraulic machine.

The following numbered sentences form part of the Summary of the Invention and thus represent elements of the present invention:
1. A device for controlling a Kaplan-type hydraulic machine, with an impeller unit (4), including a first pump assembly (2) with a variable speed drive and an accumulator (5), a hydraulic cylinder (6), two pilot-operated check valves (4.1, 4.3), and two pilot valves (4.2, 4.4) to unlock check valves (4.1, 4.3), wherein first pump assembly (2) includes at least one pump with reversible delivery direction which is connected with the variable speed pump drive such that the pumps can be driven by the pump drive in both delivery directions, and wherein the device also includes a collection and expansion tank (1), characterized in that, impeller unit (4) includes a second pump assembly (3) with a variable speed pump drive, a hydraulic rotary union (7), a throttle (4.9), two additional pilot-operated check valves (4.7, 4.13) and two additional pilot valves (4.8, 4.14) to unlock additional check valves (4.7, 4.13), and wherein second pump assembly (3) includes an additional pump with reversible delivery direction, which is connected with the associated variable speed pump drive, so that the additional pump can be operated in both delivery direction by the pump drive, and wherein a first port of first pump assembly (2) is connected via a first control line and via hydraulic rotary union (7) with a first side of hydraulic cylinder (6), and a second port of first pump assembly (2) is connected via a second control line and via the hydraulic rotary union with a second side of hydraulic cylinder (6), and wherein a pilot-operated check valve (4.1, 4.3) respectively is located in partial sections of the control line which extend from first pump assembly (2) to hydraulic rotary union (7) and which are oriented such that, in every state of check valves (4.1, 4.3), hydraulic fluid can pass through in direction toward hydraulic rotary union (7), and wherein one side of the pump of second pump assembly (3) is connected with collection and expansion tank (1), and the other side is connected via a pressure line with a partial section of the first control line which extends between the respective check valve (4.1) and hydraulic rotary union (7), and wherein a check valve (4.13) is arranged in the pressure line which is oriented such that in every state of check valve (4.13) hydraulic fluid can pass through in direction toward the first control line, and wherein accumulator (5) is connected via throttle (4.9) with a partial section of the second control line which extends between respective check valve (4.3) and hydraulic rotary union (7), and wherein a check valve (4.7) is arranged parallel to throttle (4.9) in such a way that in every state of check valve (4.7) hydraulic fluid can pass through check valve (4.7) from the second control line to accumulator (5), and wherein impeller unit (4) moreover includes lines which respectively connect accumulator (5) with check valves (4.1, 4.3, 4.7, 4.13) in order to be able to unlock check valves (4.1, 4.3, 4.7, 4.13), and wherein pilot valves (4.2, 4.4, 4.8, 4.14) are respectively arranged in the lines between accumulator (5) and check valves (4.1, 4.3, 4.7, 4.13) in such a way that one of the pilot valves (4.2, 4.4, 4.8, 4.14) respectively can unlock a check valve (4.1, 4.3, 4.7, 4.13).
2. The device according to sentence 1, wherein the device includes a bypass unit (8), and wherein bypass unit (8) is connected with collection and expansion tank (1) and with accumulator (5), and wherein bypass unit (8) includes a third pump assembly (8.1), and wherein third pump assembly (8.1) includes a drive and a pump which is connected with the drive.
3. The device according to sentence 1 or 2, wherein hydraulic cylinder (6) is designed as a double rod cylinder.
4. The device according to sentence 1 or 2, wherein hydraulic cylinder (6) is designed as a differential cylinder.
5. The device according to one of the preceding sentences, wherein first pump assembly (2) includes a first pump and a second pump with reversible delivery direction in each case, which are connected with the variable speed pump drive in such a way that the pumps can be driven by the pump drive in both delivery directions, and wherein a port of the first pump is connected via a first control line and via hydraulic rotary union (7) with a first side and a port of the second pump is connected via a second control line and via the hydraulic rotary union with a second side of hydraulic cylinder (6), and wherein the remaining ports of the first and second pump are each connected with collection and expansion tank (1), so that in a drive direction of first pump assembly (2) the first pump can deliver hydraulic fluid from collection and expansion tank (1) in the direction of hydraulic cylinder (6) and the second pump can deliver hydraulic fluid from the side of hydraulic cylinder (6) into collection and expansion tank (1).
6. The device according to sentences 2 and 3, wherein first pump assembly (2) includes precisely one pump with equal delivery volumes in both rotational directions, and wherein the ports of the pump are connected with the control lines.
7. The device according to sentence 6, wherein the pump of first pump assembly (2) is designed as a 4Q piston pump.
8. The device according to sentence 7, wherein the pump of first pump assembly (2) includes a flushing connection which is connected with bypass unit (8), and wherein a throttle is arranged in the respective connecting line, and wherein a pre-tensioned check valve is arranged in a return line from bypass unit (8) to collection and expansion tank (1).
9. The device according to one of the preceding sentences, wherein impeller unit (4) includes an additional throttle (4.12) and a 3/2 way valve (4.11), wherein throttle (4.12) and 3/2 way valve (4.11) are arranged in a line that extends from the pressure line to collection and expansion tank (1).
10. The device according to one of the preceding sentences in conjunction with sentence 4, wherein the second control line is connected with a rod side of hydraulic cylinder (6).
11. The device according to sentence 4 or 10 in junction with sentence 5, wherein the first and second pump of first pump arrangement (2) is designed as a gear pump.
12. The device according to one of the preceding sentences in conjunction with sentence 9, wherein the pump of second pump assembly (3) is designed as a gear pump or as a piston pump without flushing.
13. The device according to one of the preceding sentences, wherein impeller unit (4) includes a flow sensor (4.10) which is arranged in the line that extends between accumulator (5) and the second control line.
14. The device according to one of the preceding sentences, wherein impeller unit (4) includes two pressure relief valves (4.5, 4.6) one of which is connected with the first control line and the other is connected with the second control line.
15. The device according to one of the preceding sentences, wherein impeller unit (4) includes an additional throttle, an emergency shut-off valve (9.71), and an emergency shut-off solenoid valve (9.72).
16. The device according to one of the preceding sentences, wherein the device includes a wicket gate (9) which is connected with collection and expansion tank (1).
17. The device according to sentence 2 and 16, wherein wicket gate unit (9) includes an accumulator (9.5) and wherein bypass unit (8) is connected with accumulator (9.5) of wicket gate unit (9).
18. The device according to one of the sentences 2 to 17, wherein bypass unit (8) includes a filter unit (8.2).
19. The device according to one of the sentences 2 to 18, wherein bypass unit (8) includes a cooling unit (8.3).

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1A is a device according to the invention in a first embodiment;

FIG. 1B is a device according to the invention in a second embodiment; and

FIG. 2 is a device according to the invention in an additional embodiment.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

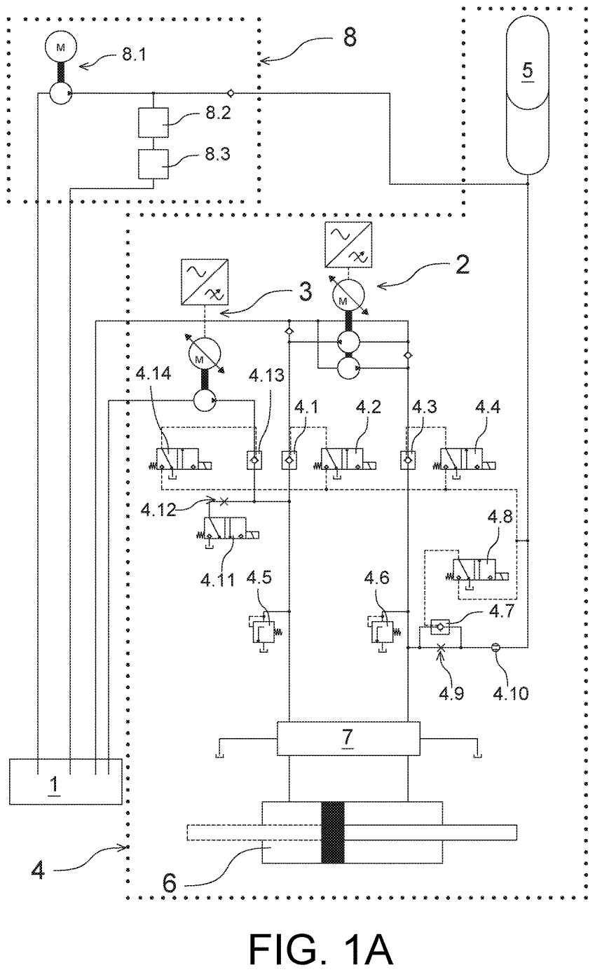

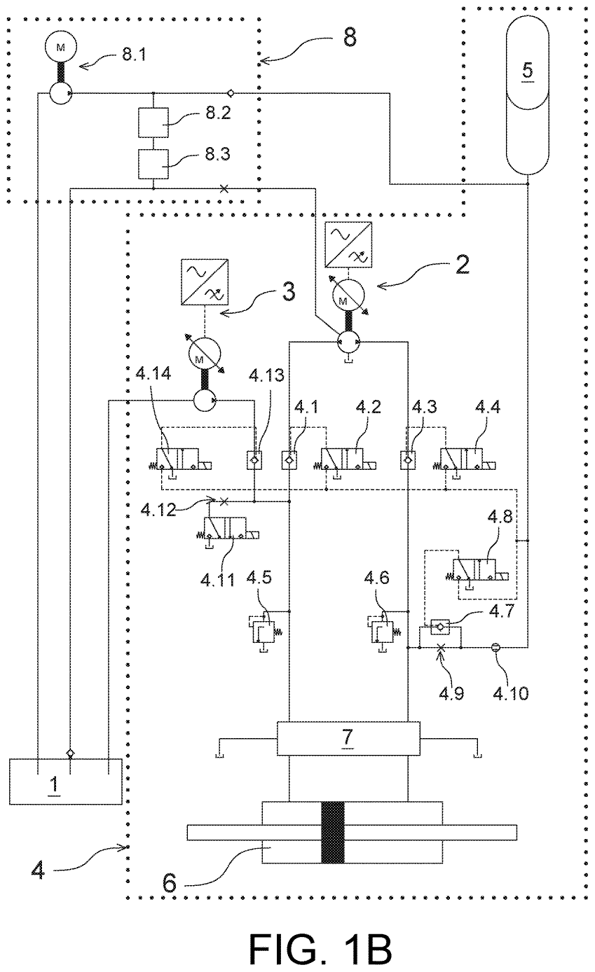

FIG. 1A schematically illustrates a first embodiment of a device according to the present invention for controlling a Kaplan-type hydraulic machine. The device serves to adjust the pitch angle of the impeller blades. The device includes a collection and expansion tank, designated 1, a first pump assembly, designated 2, a second pump assembly, designated 3, an accumulator, designated 5, and a hydraulic cylinder, designated 6. Hydraulic cylinder 6 actuates the adjustment mechanism of the impeller blades, which is not shown in FIG. 1A, and is part of the rotating system. Hydraulic cylinder 6 can be designed as a double-rod cylinder or as a differential cylinder. In a double-rod cylinder, the pressurized surfaces, and volumes of the two cylinder chambers are equally sized, whereas in a differential cylinder they are differently sized. In a differential cylinder, the two sides of the cylinder are distinguished. The side where the rod is located is referred to as the rod side, and the other side as the piston side. Hydraulic cylinder 6 is connected to the rest of the device by a hydraulic rotary union, which is designated 7. Each of the two pump assemblies 2 and 3 includes a variable-speed pump drive. First pump assembly 2 serves to control hydraulic cylinder 6 in a first operating mode, and second pump assembly 3 serves to control hydraulic cylinder 6 in a second operating mode. The first operating mode is characterized in that the impeller blades move rapidly. This operating mode typically includes approximately 10% of the total operating time. The second operating mode is characterized in that the impeller blades are held in a fixed position or move very slowly. This second operating mode typically includes approximately 90% of the total operating time.

The device shown in FIG. 1A, in the arrangement provided for the first operating mode (with respect to first pump arrangement 2), closely resembles the device known from DE 10 2017 106 693 B3. Also in this case, first pump arrangement 2 includes two pumps with reversible delivery direction. In FIG. 1A, the two pumps are arranged on a shaft, which is driven by the variable-speed pump drive connected to the shaft. However, other designs are also possible, such as the pumps being driven by the pump drive via a gearbox. It is even conceivable that the pump drive could include a motor and a frequency converter for each of the two pumps. The following description refers to the embodiment shown in FIG. 1A. In this arrangement, one connection of each pump is connected to a control line of hydraulic cylinder 6, so that, in one direction of rotation of the shaft, one pump delivers hydraulic fluid toward hydraulic cylinder 6 and the other pump draws hydraulic fluid from hydraulic cylinder 6. In the other direction of rotation of the shaft, the process is exactly reversed. Unlike the device described in DE 10 2017 106 693 B3, FIG. 1A shows rotary joint 7 positioned between hydraulic cylinder 6 and the connections of first pump assembly 2. Hydraulic rotary union 7 merely performs the transmission to the rotating system.

Like the device described in DE 10 2017 106 693 B3, the device shown in FIG. 1A includes two pilot-operated check valves, designated 4.1 and 4.3, and two pilot valves, designated 4.2 and 4.4. The right port of the lower pump is connected to the right side of hydraulic cylinder 6 via pilot-operated check valve 4.3, and the left port of the upper pump is connected to the left side of hydraulic cylinder 6 via pilot-operated check valve 4.1. The lines from first pump assembly 2 to hydraulic rotary union 7, in which pilot-operated check valves 4.1 and 4.3 are located, are hereinafter referred to as control lines. The other connections of the pumps are each directly connected to the collection and expansion tank 1. In other words, in one direction of rotation of the shaft, the lower pump pumps hydraulic fluid from the collection and expansion tank 1 into the right side of hydraulic cylinder 6, and at the same time the upper pump pumps hydraulic fluid from the left side of hydraulic cylinder 6 into the storage and expansion tank 1. In the other direction of rotation of the shaft, the volume flows are reversed. In each case, it is assumed that check valves 4.1 and 4.3 are unlocked (see below in the description of the operating conditions).

In contrast to the device disclosed in DE 10 2017 106 693 B3, hydraulic rotary union 7 causes a permanent outflow of hydraulic fluid into collection and expansion tank 1. The hydraulic fluid required for this comes (in both operating modes) from collection and expansion tank 1 and accumulator 5, which is connected to one of the control lines. An adjustable throttle, designated 4.9, is located between the relevant control line and reservoir 5. A pilot-operated check valve, designated 4.7, is arranged in parallel with throttle 4.9. Analogous to check valves 4.1 and 4.3, check valve 4.7 is controlled by a pilot valve, designated 4.8. In the first operating mode, check valve 4.7 is opened, so that throttle 4.9 is inactive. In the second operating mode, check valve 4.7 is closed, so that throttle 4.9 is active (referenced below, in the description of the operating states).

The shaft of first pump assembly 2 is driven by a variable-speed pump drive that can operate in both directions of rotation. The pump drive typically includes an electric servomotor powered by a frequency converter. Optionally, the pump drive of first pump assembly 2 is suitable for 4Q operation.

The shaft of second pump assembly 3 is also driven by a variable-speed pump drive that can operate in both directions of rotation. The pump drive typically includes an electric servomotor powered by a frequency converter. The pump drive of second pump assembly 3 is optionally suitable for 2Q operation.

The shaft of second pump assembly 3 is connected to only one pump. One connection of this pump is connected with collection and expansion tank 1, and the other connection is connected to a control line. The line from second pump assembly 3 leads into the control line to which accumulator 5 is not connected. The line from second pump assembly 3 to the corresponding control line is referred to below as the pressure line. The junction of the pressure line with the corresponding control line is also located between the associated pilot-operated check valve (FIG. 1A—check valve 4.1) and hydraulic rotary union 7. A pilot-operated check valve, designated 4.13, is installed in the pressure line. Check valve 4.13 is controlled by a pilot valve, designated 4.14. Optionally, the pressure line and the control line connected to it are connected to collection and expansion tank 1 via a throttle and a 3/2-way valve. The throttle is identified 4.12 and the 3/2-way valve is designated 4.11. When 3/2-way valve 4.11 is activated, a throttled bypass to the expansion tank (1) opens (see the description of operating states below).

The pumps of first pump assembly 2 can be designed as gear pumps or as piston pumps without flushing. Gear pumps allow for easy adaptation to a hydraulic cylinder that is designed as a differential cylinder. In this case, the pumps of first pump assembly 2 are optionally designed as double gear pumps. Piston pumps are suitable for hydraulic cylinders designed as double-rod cylinders. The pump of second pump assembly 3 can be designed as a piston pump with or without flushing. When the pump is flushed, the bypass line with throttle 4.12 and 3/2-way valve 4.11 can be omitted. If the pump of second pump assembly 3 is designed as a piston pump without flushing or as a simple gear pump, then the bypass line with throttle 4.12 and 3/2 directional valve 4.11 is required to avoid critical low speeds that can eventually damage the pump of second pump assembly 3.

If the pumps used have designated pressure and suction ports, the pressure ports should optionally always be connected to hydraulic cylinder 6 and the suction ports to collection and expansion tank 1.

Optionally, the device according to the present invention may include two pressure relief valves connected to the control lines. In FIG. 1A, the optional pressure relief valves are designated 4.5 and 4.6. Additionally, a flow sensor may optionally be arranged in the line leading from accumulator 5 to the respective control line. In FIG. 1A, such an optional flow sensor is designated 4.10. This can be used to monitor the amount of hydraulic fluid being drawn from the accumulator.

The device according to the present invention may optionally include a so-called bypass unit, which represents an alternative accumulator charging option (see below in the description of the operating states). FIG. 1A shows such a bypass unit and is designated 8. Bypass unit 8 is connected to collection and expansion tank 1 and the accumulator 5 and includes a third pump assembly, which is designated 8.1. Third pump assembly 8.1 includes a drive and a pump connected to the drive. In an optional embodiment, third pump assembly 8.1 includes a constant-speed AC motor with a flanged gear pump. However, third pump assembly 8.1 may also be configured differently. Optionally, the bypass unit may include a filter unit and/or a cooling unit. In FIG. 1A, these units are indicated by rectangles and designated 8.2 and 8.3. Bypass unit 8 includes an electrically controlled changeover valve (not shown). When the changeover valve is closed, accumulator 5 is charged via the pump of bypass unit 8. If the changeover valve is open, bypass unit 8 filters and/or cools the hydraulic fluid in collection and expansion tank 1 in the unpressurized circuit (provided that bypass unit 8 includes the corresponding components).

If hydraulic cylinder 6 is designed as a differential cylinder, accumulator 5 is optionally connected to the control line associated with the rod side of hydraulic cylinder 6. The inventors have recognized that in this case, the expected leakage at hydraulic rotary union 7 is lower. If a differential cylinder is used, it is advantageous if the flow ratio of the two pumps of second pump unit 3 is adapted to the surface ratio of the cylinder. This adaptation does not have to be perfect since the residual difference is compensated for by accumulator 5. However, this exchange volume only comes into play in the second operating mode.

The embodiment of a device according to the present invention shown in FIG. 1A is suitable for hydraulic cylinders of any type, that is, for differential and double-rod cylinders. FIG. 1B shows an embodiment that is suitable only for double-rod cylinders and is optimized for them. Since the embodiments according to FIGS. 1A and 1B coincide to a considerable extent, only the differences between the embodiment according to FIG. 1B and the embodiment according to FIG. 1A are described below.

In the embodiment shown in FIG. 1B, first pump assembly 2 includes only one pump with equal delivery rates in both directions of rotation. This pump is optionally designed as a 4Q piston pump. The two connections of the pump are connected to the control lines. The connections from first pump assembly 2 to collection and expansion tank 1 shown in FIG. 1A are omitted.

In the embodiment according to FIG. 1B, bypass unit 8 is no longer optional, as the accumulator can no longer be filled with the assistance of pump assembly 2. This can then only be done via the bypass unit, which, on the other hand, offers the advantage that the accumulator can be filled without interrupting regular operation (see also below).

Optionally, the pump may include a flushing oil connection, which is connected to bypass unit 8. A throttle is installed in the corresponding connecting line and can be used to regulate the flow rate of flushing oil. Moreover, this optional configuration includes a pre-tensioned check valve in the return line from bypass unit 8 to collection and expansion tank 1. When third pump assembly 8.1 operates in unpressurized circulation (that is, with the changeover valve open), part of the circulating volume flows through the pump of first pump assembly 2 to cool it. The pump, of first pump assembly 2, can be protected from potential wear by this optional arrangement.

It should be noted that the embodiments of the device according to the present invention shown in FIGS. 1A and 1B, in contrast to the device from DE 10 2017 106 693 B3, do not include the elements disclosed therein for an emergency shut-off. This is because, in a Kaplan-type hydraulic machine, the emergency shut-off is not (or only to a minor extent) achieved via the position of the impeller blades, but (primarily) by closing the wicket gate. An embodiment of the device according to the present invention with emergency shut-off functionality is described below.

The different operating states of the devices shown in FIGS. 1A and 1B are described below.

The first operating state relates to the control of hydraulic cylinder 6. This operating state is divided, as already described above, into a first operating mode (rapid change of the position of the impeller blades) and a second operating mode (holding the position of the impeller blades or moving them very slowly).

In the first operating mode, second pump assembly 3 is deactivated while first pump assembly 2 is simultaneously activated. Check valves 4.1 and 4.3 in the control lines, as well as the check valve to the accumulator 4.7, are opened, and check valve 4.13 in the pressure line of second pump assembly 3 is closed (if open). Analogous to the device described in DE 10 2017 106 693 B3, the speed-controlled drive of first pump assembly 2 can now control hydraulic cylinder 6 in both directions in an efficient closed circuit in 4Q operation. Only the energy required to overcome the load and friction at the set speed needs to be supplied.

In the embodiment according to FIG. 1A, any possibly required exchange volume can either be drawn in from collection and expansion tank 1 or pushed into the accumulator 5 via check valve 4.7 which is unlocked in the first operating mode.

The open connection to the accumulator 5 ensures in every embodiment that the pressure in the control line on the accumulator side does not drop, even during rapid movements. Thus, the drive for first pump assembly 2 operates firstly under energetically optimal pressure conditions; secondly, it prevents a potential critical pressure of <5 bar, which could lead to pump cavitation. The drive of first pump assembly 2 is designed to achieve the maximum adjustment speed. Here, too, no control energy is drawn from accumulator 5. The stored hydraulic fluid serves only to lubricate and cool hydraulic rotary union 7. In the embodiment according to FIG. 1B, the internal losses of the pump of the first pump assembly are also compensated by accumulator 5.

In the second operating mode, the position of hydraulic cylinder 6 is maintained or very slowly regulated solely by second pump assembly 3. First pump assembly 2 is inactive. Pilot-operated check valves 4.1 and 4.3 in the control lines are in the closed position. This means that pilot valves 4.2 and 4.4 are in the spring-loaded, de-energized position. Accumulator 5 is connected to a port of hydraulic rotary union 7 via (optionally adjustable) throttle 4.9 and pilot-operated check valve 4.7 connected in parallel to it and serves primarily as a supply reservoir for hydraulic fluid as a lubricant and coolant for one half of hydraulic rotary union 7.

In the second operating mode, pilot-operated check valve 4.7 to accumulator 5 is in the closed position. Thus, only throttle 4.9 is active, reducing the cross-section and thereby the resulting pressure at hydraulic rotary union 7. This also reduces the leakage of hydraulic rotary union 7 occurring on the accumulator connection side. The pressure on the accumulator side, combined with the leakage on the non-accumulator side, causes cylinder 6 to move slowly towards the non-accumulator side. To hold hydraulic cylinder 6 in position, second pump assembly 3 must work against this movement. Second pump assembly 3 must therefore compensate for the leakage at hydraulic rotary union 7 on the non-accumulator side. Since second pump assembly 3 is a speed-controlled drive, energy is supplied only in accordance with the actual load and the actual required flow rate. Second pump assembly 3 must be designed to be large enough to compensate for the leakage and to perform small control movements. To ensure the minimum speed in each case, of second pump assembly 2, which depends on the applied pressure, the 3/2-way valve 4.11 with upstream throttle 4.12 is integrated into the pressure line of second pump assembly 3 (if it is not a flushed piston pump). When the solenoid valve is switched, a throttled bypass to collection and expansion tank 1 is opened. The resulting leakage must also be compensated for by second pump assembly 3, which leads to an increase in the delivery volume and thus to an increase in speed. This prevents critically low speeds that could damage the pump of second pump assembly 3 in the long term. Critically low speeds can occur with reduced leakage at hydraulic rotary union 7, which in turn can be caused by low ambient temperatures, since the viscosity of the hydraulic fluid also decreases at low temperatures. Such bypass operation of second pump assembly 3 can also be used to heat the hydraulic fluid.

With second pump assembly 3, smaller control movements in both directions can also be made:
If hydraulic cylinder 6 is to be moved toward the accumulator side, the associated pump must build up pressure and deliver fluid to the accumulator side.
If hydraulic cylinder 6 is to be moved toward the non-accumulator side, the corresponding pump must relieve pressure and drain the hydraulic fluid into collection and expansion tank 1. For this purpose, pilot-operated check valve 4.13 in the pressure line of the auxiliary drive is opened via the corresponding solenoid valve 4.14.

If the necessary flow rate of hydraulic fluid for a required control movement exceeds the maximum flow rate that can be provided by second pump assembly 3, a change from the second operating mode to the first operating mode takes place.

The accumulator pressure should be at least as high as the maximum pressure necessary to move hydraulic cylinder 6 against the hydraulic load and against friction. Otherwise, during a required control movement, the accumulator may first charge up to the specified maximum pressure before any cylinder movement can occur. In many cases, this will correspond to the conventional minimum system pressure (p_{R}). Typical values for p_{R} in the high-pressure range are 80 or 110 bar. Since the accumulator only needs to hold hydraulic fluid for lubrication and cooling, as well as some displacement volume, but is not required for control of the hydraulic cylinder, the accumulator volume depends solely on the selected charging interval in the accumulator and the required displacement volume. The shorter the accumulator charging interval, the smaller the accumulator volume, and vice versa. For the upper nominal accumulator pressure, the maximum pressure according to IEC 61362 can be used for p0max: p0max=160 bar.

The function of storage charge can be implemented in the embodiment according to FIG. 1A in two alternative ways, which can also be combined.

Similar to the device described in DE 10 2017 106 693 B3, storage unit 5 can be charged by the drive mechanism of first pump assembly 2. For this purpose, the drive of second pump assembly 3 is deactivated and both check valves 4.1 and 4.3 in the control lines are closed. When the drive of first pump assembly 2 delivers fluid into the accumulator side, accumulator 5 is charged. Due to leakage from the hydraulic rotary union and the inactive control of the drive of second pump assembly 3 and the drive of first pump assembly 2, hydraulic cylinder 6 will slowly drift in this situation. Since the supply of hydraulic fluid for lubrication and cooling must be given higher priority than control accuracy in this case, this behavior is acceptable for the short accumulator charging period.

Alternatively, a bypass unit 8 may be provided for accumulator charging. The functionality of same with optional filter and cooling functionality has already been described above. If a bypass unit 8 is provided for accumulator charging, then the advantage is that the accumulator charging function can be carried out redundantly. If accumulator charge does not work with bypass unit 8, the drive of first pump assembly 2 can be used for accumulator charging.

In the embodiment according to FIG. 1B, only bypass unit 8 is available for accumulator charging.

In any case, the lower changeover point for accumulator charging p₀ₘᵢₙ can be selected to be very low, since neither hydraulic fluid is required for control in normal operation nor hydraulic fluid for an emergency shut-off function.

The inventors designed the inventive device for a selected Katlan-type of hydraulic machine. Oil is used as hydraulic fluid. In the example given, the accumulator had a usable capacity of 40 liters of oil between p_{R}=110 bar and p₀ₘₐₓ=160 bar. The lower changeover point p₀ₘᵢₙ was set to 120 bar. This means that the volume between p_{R} and p₀ₘᵢₙ is 10 liters. With a realistic oil leakage rate of 2 l/min for a standard high-pressure hydraulic rotary union, the accumulator must be recharged after 15 minutes. If the accumulator recharge fails, the remaining 10 liters provide lubricating and cooling oil for an additional 5 minutes to safely shut down the machine.

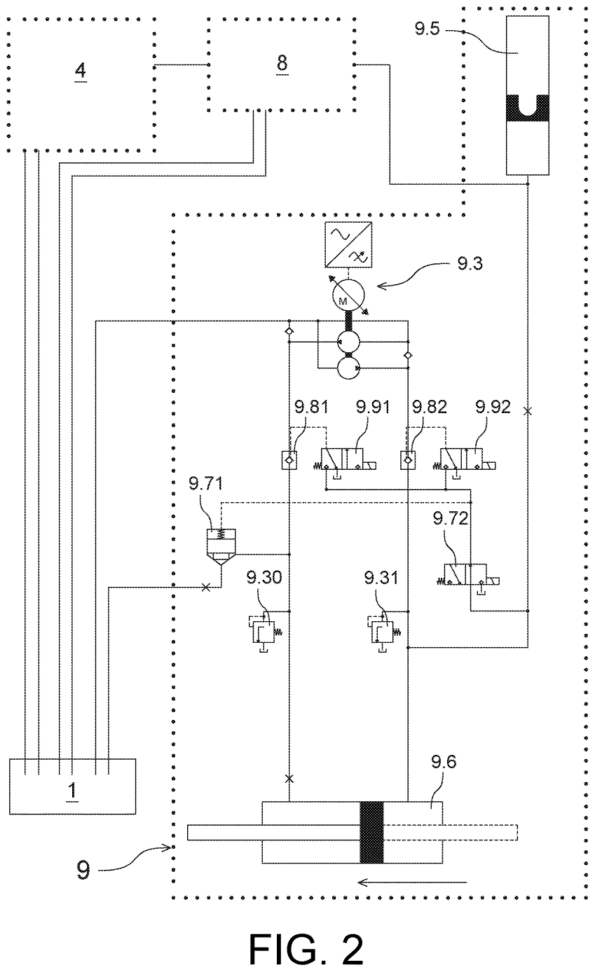

In a Kaplan-type hydraulic machine, the position of the impeller blades as well as the vanes of the wicket gate are controlled. In principle, the two control units can be independent of each other, with the control being managed by a common control unit. However, the device according to the invention as shown in FIG. 1 can be combined especially advantageously with a device as described in DE 10 2017 106 693 B3. Such a combination is shown in FIG. 2. For the sake of clarity, various elements of the device according to FIG. 1 are combined into a so-called impeller unit. The relevant elements are outlined in FIG. 1 by the dotted line, identified with 4.

FIG. 2 shows a device according to the present invention for controlling a Kaplan-type hydraulic machine, wherein the device can control both the position of the impeller blades and the position of the blades of the wicket gate. For controlling the position of the impeller blades, the device includes an impeller unit, which is designated 4. The impeller unit can be constructed according to FIG. 1A or FIG. 1B. For controlling the position of the guide vane assembly, the device includes a so-called wicket gate unit. The relevant elements are framed in FIG. 2 by the dotted line, designated 9. Wicket gate unit 9 shown in FIG. 2 represents a specific embodiment. However, the wicket gate unit 9 could also be constructed differently. For the various possible embodiments of wicket gate unit assembly 9, reference is made to DE 10 2017 106 693 B3, the description of which is included as part of this document for the purpose of further explaining the construction and operation of a wicket gate unit 9. For this reason, in FIG. 2, the designations of the elements of wicket gate unit 9 have been adapted to the designations in DE 10 2017 106 693 B3. The prefix “9.” has been added to each element to indicate that they belong to wicket gate unit 9. It is therefore only mentioned here for the sake of completeness that impeller unit 4 and the wicket gate unit 9 use a common collection and expansion tank 1, that accumulator 9.5 of the wicket gate unit 9 is designed as a piston accumulator, and that the wicket gate unit 9 shown in FIG. 2 does not have the optional quick-closing functionality. The device according to the present invention, as shown in FIG. 2, can moreover optionally include a bypass unit 8, which provides the accumulator charging function and, if applicable, a filter and cooling function for impeller unit 4 and wicket gate unit 9. If the impeller unit is designed according to FIG. 1B, then the bypass unit 8 is no longer optional. Furthermore, wicket gate unit 9 can be designed analogously to impeller unit according to FIG. 1B, that is, pump assembly 9.3 has only one pump, and the connecting lines from pump assembly 9.3 to the collection and expansion tank are omitted. In this case, hydraulic cylinder 9.6 must act as a double-rod cylinder. In this case, the pump of pump assembly 9.3 can also be supplied optionally with flushing oil via bypass unit 8.

Finally, it should be noted that there are Kaplan pumps in which the impeller blades must be set to a predefined position in the event of an emergency shutdown. This must still function even if first pump assembly 2 were to fail. To achieve this, an impeller unit 4 according to the present invention can easily be equipped with the components necessary for emergency shut-off functionality. These are the same components used in a wicket gate 9 for emergency shut-off. These include at least elements 9.71 (emergency shut-off valve), 9.72 (emergency shut-off solenoid valve), and at least one throttle. As with a wicket gate unit 9, the energy required for the emergency shut-off is then supplied by accumulator 5. Additional optional components—for example, for quick shut-off, or if more than one throttle is to be used to set the maximum closing speed—can be easily integrated into impeller unit 4 in a manner analogous to the descriptions in DE 10 2017 106 693 B3.

The inventors redesigned a total of six different Kaplan turbines which had previously been constructed conventionally (see the second section of this document) in accordance with the current invention and compared the design of the current invention with the conventional design in terms of required storage volume, storage costs, and tank volume. Considering only the impeller adjustment, the following average reductions were achieved with the inventive design:
Storage volume: −77%
Storage costs: −66%
Tank volume: −54%.

When considering the combined impeller and wicket gate adjustment, the following average reductions resulted with the design according to the invention:
Storage volume: −69%
Storage costs: −58%
Tank volume: −62%.

### REFERENCE IDENTIFICATION LISTING

1 collecting and expansion tank
2 first pump arrangement
3 second pump arrangement
4 impeller
5 accumulator
6 hydraulic cylinder
7 hydraulic rotary union
8 bypass unit
9 wicket gate
4.1 check valve
4.2 pilot valve
4.3 check valve
4.4 pilot valve
4.5 pressure relief valve
4.6 pressure relief valve
4.7 check valve
4.8 pilot valve
4.9 throttle
4.10 flow sensor
4.11 3/2-way valve
4.12 throttle
4.13 check valve
4.14 pilot valve
8.1 third pump assembly
8.2 filter unit
8.3 cooling unit
9.3 pump unit of wicket gate unit
9.5 accumulator of wicket agate unit
9.6 hydraulic cylinder of wicket gate unit
9.30 pressure relief valve
9.31 pressure relief valve
9.71 emergency shut-off valve
9.72 emergency shut-off solenoid valve
9.81 check valve
9.82 check valve
9.91 pilot valve
9.92 pilot valve

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A device for controlling a Kaplan-type hydraulic machine, the device comprising:
an impeller unit, which includes:
a first pump assembly, which includes a first variable speed pump drive and at least one first pump with a reversible delivery direction, the at least one first pump being connected with the first variable speed pump drive such that the at least one first pump is configured for being driven by the first variable speed pump drive in two delivery directions, the first pump assembly including at least one first port;
an accumulator;
a hydraulic cylinder, which includes a first side and a second side;
two pilot-operated check valves, which include a first pilot-operated check valve and a second pilot-operated check valve;
two pilot valves, which are configured for unlocking the two pilot-operated check valves;
a second pump assembly, which includes a second variable speed pump drive and a second pump with a reversible delivery direction, the second pump being connected with the second variable speed pump drive such that the second pump is configured for being driven by the second variable speed pump drive in two delivery directions, the second pump assembly including at least one second port, the second pump of the second pump assembly including a first side and a second side;
a hydraulic rotary union;
a throttle;
two additional pilot-operated check valves, which include a first additional pilot-operated check valve and a second additional pilot-operated check valve;
two additional pilot valves, which are configured for unlocking the two additional pilot-operated check valves;
a collection and expansion tank;
a plurality of lines, the plurality of lines include a first control line and a second control line, the first control line including a first section and a second section, the second control line including a first section and a second section, the plurality of lines further including a pressure line, the plurality of lines including a group of lines which respectively connect the accumulator with the two pilot-operated check valves and the two additional pilot-operated check valves so as to be able to unlock the two pilot-operated check valves and the two additional pilot-operated check valves,
wherein the at least one first port of the first pump assembly is connected via the first control line and via the hydraulic rotary union with the first side of the hydraulic cylinder, the at least one second port of the second pump assembly being connected via the second control line and via the hydraulic rotary union with the second side of the hydraulic cylinder,
wherein the two pilot-operated check valves are located respectively in the first section of the first control line and the first section of the second control line, the first section of the first control line and the first section of the second control line each extending from the first pump assembly to the hydraulic rotary union, the first section of the first control line and the first section of the second control line being oriented such that, in every state of the two pilot-operated check valves, a hydraulic fluid is able to pass through in a direction toward the hydraulic rotary union,
wherein the first side of the second pump of the second pump assembly is connected with the collection and expansion tank, and the second side of the second pump of the second pump assembly is connected via the pressure line with the second section of the first control line, the second section of the first control line extending between the first pilot-operated check valve and the hydraulic rotary union,
wherein the second additional pilot-operated check valve is arranged in the pressure line, the second additional pilot-operated check valve being oriented such that, in every state of the second additional pilot-operated check valve, the hydraulic fluid is able to pass through in a direction toward the first control line,
wherein the accumulator is connected via the throttle with the second section of the second control line, the second section of the second control line extending between the second pilot-operated check valve and the hydraulic rotary union,
wherein the first additional pilot-operated check valve is arranged parallel to the throttle in such a way that, in every state of the first additional pilot-operated check valve, the hydraulic fluid is able to pass through the first additional pilot-operated check valve from the second control line to the accumulator,
wherein the two pilot valves and the two additional pilot valves are respectively arranged in the group of lines between the accumulator and the two pilot-operated check valves and the two additional pilot-operated check valves such that the two pilot valves and the two additional pilot valves are configured for unlocking respectively the two pilot-operated check valves and the two additional pilot-operated check valves.

2. The device according to claim 1, wherein the device includes a bypass unit, wherein the bypass unit is connected with the collection and expansion tank and with the accumulator, wherein the bypass unit includes a third pump assembly, and wherein the third pump assembly includes a drive and a pump which is connected with the drive.

3. The device according to claim claim 1, wherein the hydraulic cylinder is a double rod cylinder.

4. The device according to claim claim 1, wherein the hydraulic cylinder is a differential cylinder.

5. The device according to claim 1, wherein the at least one first pump includes a first first pump and a second first pump with the reversible delivery direction in each case, the first first pump and the second first pump being connected with the first variable speed pump drive such that the first first pump and the second first pump are each configured for being driven by the first variable speed pump drive in the two delivery directions, wherein the at least one first port includes a first first port and a second first port and a plurality of remaining first ports, wherein the first first pump includes the first first port and the second first pump includes the second first port, wherein the first first pump and the second first pump include the plurality of remaining first ports, the plurality of lines including a first first pump control line and a second first pump control line, wherein the first first port of the first first pump is connected via the first first pump control line and via the hydraulic rotary union with the first side of the hydraulic cylinder, and the second first port of the second first pump is connected via the second first pump control line and via the hydraulic rotary union with the second side of the hydraulic cylinder, and wherein the plurality of remaining first ports of the first first pump and the second first pump are each connected with the collection and expansion tank such that, in a drive direction of the first pump assembly, the first second pump is configured to deliver the hydraulic fluid from the collection and expansion tank in a direction of the hydraulic cylinder and the second first pump is configured to deliver the hydraulic fluid from the first side or the second side of the hydraulic cylinder into the collection and expansion tank.

6. The device according to claim 1, wherein the device includes a bypass unit, wherein the bypass unit is connected with the collection and expansion tank and with the accumulator, wherein the bypass unit includes a third pump assembly, and wherein the third pump assembly includes a drive and a pump which is connected with the drive, wherein the first pump assembly includes only one of the at least one first pump, which is the first pump, the first pump being configured for having equal delivery volumes in the two delivery directions of the first pump, the two delivery directions being two rotational directions respectively, wherein the first pump includes the first port, which is connected with the first control line.

7. The device according to claim 6, wherein the first pump of the first pump assembly is a 4Q piston pump.

8. The device according to claim 7, wherein the device includes an additional throttle, a connecting line, a pre-tensioned check valve, and a return line, wherein the at least one first pump of the first pump assembly includes a flushing connection which is connected with the bypass unit, wherein the additional throttle is arranged in the connecting line, and wherein the pre-tensioned check valve is arranged in the return line from the bypass unit to the collection and expansion tank.

9. The device according to claim 1, wherein the device includes an additional line, wherein the impeller unit includes an additional throttle and a 3/2 way valve, wherein the additional throttle and the 3/2 way valve are arranged in the additional line that extends from the pressure line to the collection and expansion tank.

10. The device according to claim 1, wherein the hydraulic cylinder is a differential cylinder, wherein the hydraulic cylinder includes a rod side, wherein the second control line is connected with the rod side of the hydraulic cylinder.

11. The device according to claim 10, wherein the at least one first pump includes a first first pump and a second first pump with the reversible delivery direction in each case, the first first pump and the second first pump being connected with the first variable speed pump drive such that the first first pump and the second first pump are each configured for being driven by the first variable speed pump drive in the two delivery directions, wherein the at least one first port includes a first first port and a second first port and a plurality of remaining first ports, wherein the first first pump includes the first first port and the second first pump includes the second first port, wherein the first first pump and the second first pump include the plurality of remaining first ports, the plurality of lines including a first first pump control line and a second first pump control line, wherein the first first port of the first first pump is connected via the first first pump control line and via the hydraulic rotary union with the first side of the hydraulic cylinder, and the second first port of the second first pump is connected via the second first pump control line and via the hydraulic rotary union with the second side of the hydraulic cylinder, and wherein the plurality of remaining first ports of the first first pump and the second first pump are each connected with the collection and expansion tank such that, in a drive direction of the first pump assembly, the first second pump is configured to deliver the hydraulic fluid from the collection and expansion tank in a direction of the hydraulic cylinder and the second first pump is configured to deliver the hydraulic fluid from the first side or the second side of the hydraulic cylinder into the collection and expansion tank, wherein the first first pump and the second first pump of the first pump assembly are each formed as a gear pump.

12. The device according to claim 1, wherein the device includes an additional line, wherein the impeller unit includes an additional throttle and a 3/2 way valve, wherein the additional throttle and the 3/2 way valve are arranged in the additional line that extends from the pressure line to the collection and expansion tank, wherein the second pump of the second pump assembly is formed as a gear pump or as a piston pump without flushing.

13. The device according to claim 1, wherein the plurality of lines includes an additional line, wherein the impeller unit includes a flow sensor which is arranged in the additional line, which extends between the accumulator and the second control line.

14. The device according to claim 1, wherein the impeller unit includes two pressure relief valves, one of which is connected with the first control line and the other of which is connected with the second control line.

15. The device according to claim 1, wherein the impeller unit includes an additional throttle, an emergency shut-off valve, and an emergency shut-off solenoid valve.

16. The device according to claim 1, wherein the device includes a wicket gate unit which is connected with the collection and expansion tank.

17. The device according to claim 16, wherein the device includes a bypass unit, wherein the bypass unit is connected with the collection and expansion tank and with the accumulator, wherein the bypass unit includes a third pump assembly, wherein the third pump assembly includes a drive and a pump which is connected with the drive, wherein the wicket gate unit includes an accumulator, and wherein the bypass unit is connected with the accumulator of the wicket gate unit.

18. The device according to claim 1, wherein the device includes a bypass unit, wherein the bypass unit is connected with the collection and expansion tank and with the accumulator, wherein the bypass unit includes a third pump assembly, wherein the third pump assembly includes a drive and a pump which is connected with the drive, wherein the bypass unit includes a filter unit.

19. The device according to claim 1, wherein the device includes a bypass unit, wherein the bypass unit is connected with the collection and expansion tank and with the accumulator, wherein the bypass unit includes a third pump assembly, wherein the third pump assembly includes a drive and a pump which is connected with the drive, wherein the bypass unit includes a cooling unit.
